(19) United States
(12) Patent Application Publication
(10) Pub. No.: US 2025/0205923 A1
(43) Pub. Date: Jun. 26, 2025

(54) METHOD FOR MANUFACTURING A PARTICLE BOARD AND PARTICLE BOARD

(71) Applicant: SWISS KRONO Tec AG, Luzern (CH)

(72) Inventors: Roger Braun, WILLISAU LU (CH); Joachim Hasch, Berlin (DE); Christian Heinemann, Willisau (CH); Fabian Noci, Wolhusen (CH)

(73) Assignee: SWISS KRONO Tec AG, Luzern (CH)

(21) Appl. No.: 18/845,650

(22) PCT Filed: Mar. 3, 2023
(86) PCT No.: PCT/EP2023/055475

§ 371 Date: Sep. 10, 2024

(30) Foreign Application Priority Data
Mar. 10, 2022 (EP) 22161409.2

(51) Int. Cl. B27N 3/00; B27N 3/02; C08L 97/02

(52) U.S. Cl. CPC B27N 3/002; B27N 3/02; C08L 97/02

(57) ABSTRACT

The invention relates to a method for manufacturing a particle board and to a particle board. In order to propose a method in which a particle board with improved properties, in particular with increased strength, can be manufactured, the following steps are provided: providing chip material; providing at least one adhesive; application of the adhesive to the chip material, whereby an adhesive content of at least 12% by weight/atro chips is applied to the chips; forming a single or multi-layered particle mat; pressing the particle mat in a press to manufacture a particle board. The invention further comprises a particle board.

### BACKGROUND OF THE INVENTION

The invention relates to a method for manufacturing a particle board and to a particle board.

Methods of the type described above are used to press chips and sawdust and/or wood shavings made from wood, for example from round wood, fresh wood, waste wood or residual wood or from annual plants such as straw or bagasse, into chip board.

For the manufacturing of particle boards, the wood, e.g. round wood or waste wood or annual plants, is comminuted into chips in a first comminution step, for example in a knife ring chipper. To manufacture fine chip material, the chips can be further comminuted in a double stream mill or an impact mill, for example. Before possible intermediate storage in silos, the chip material is usually dried. Single-pass or three-pass drum dryers or belt dryers are usually used for this purpose.

Before being pressed in a press, the chip material is fractionated, e.g. using mechanical sieves or blowers, and treated with an adhesive (binder). An adhesive content of 2 to 11% by weight/atro wood is usually used when applying binder to the chip material. The chips on which binder was applied to are scattered, e.g. by wind scattering, throw scattering or rolling, and the resulting particle mat is then pressed into a particle board, e.g. in a continuous and/or discontinuous press.

Particle boards produced using known methods have established themselves in various forms of application in several industrial and construction sectors, especially for interior design or the furniture industry.

For example, WO 2011/107900 A1 discloses a method for manufacturing a lignocellulose-containing material or WO2012/031922 A1 discloses a method for manufacturing a multi-layered lignocellulose-containing molded article with low formaldehyde emission. In addition, EP 3 736 095 A2 shows a method for manufacturing a board-shaped material from fibers.

However, particle boards only have limited strength and poor water resistance or moisture resistance, which severely limits the possible applications. Long-term or even permanent outdoor use is hardly possible for a known, optionally sheathed particle board.

### SUMMARY OF THE INVENTION

It can be regarded as an object to propose a method in which a particle board with improved properties, in particular with increased strength, can be manufactured. Furthermore, the invention is based on the object of providing a particle board with improved properties, in particular with increased strength.

The object is solved by a method for manufacturing a particle board as disclosed herein and a particle board also as disclosed herein. Dependent claims relate to advantageous further embodiments of the invention.

The method according to the invention for manufacturing a particle board has the following steps:
Providing chip material from wood;
Providing at least one adhesive,
Applicating of the adhesive to the chip material, whereby an adhesive content of at least 12% by weight/atro of wood is applied to the chips;
Forming a single or multi-layered particle mat,
Pressing the particle mat in a hot press to manufacture a particle board.

The steps of the method correspond to those of a conventional method, e.g. for manufacturing a flat pressed board. According to the invention, however, an adhesive content of at least 12% by weight/atro of wood is used. In relation to the proportion of chip material, an adhesive content of at least 15% by weight/atro wood, preferably at least 17% by weight/atro wood, particularly preferably at least 20% by weight/atro wood, very particularly preferably at least 25% by weight/atro wood is applied to the chips. Provided that an upper limit of a moisture content of the layer and/or layers of the chip mat is maintained after applying binder, any desired adhesive content can be applied to the chips. Preferably, the upper limit of the moisture content is between 1 wt. %/glued wood to 20 wt. %/glued wood, preferably between 3 wt. %/glued wood to 18 wt. %/glued wood, particularly preferably between 5 wt. %/glued wood to 15 wt. %/glued wood.

The adhesive content is expressed in relation to the chip material, i.e. the proportion of adhesive is given in relation to the weight of the chips used. In the case of chips that can absorb moisture (e.g. wood chip material), the adhesive content is based on wood that has dried to constant weight. The chip material is dried to constant weight at 103±2° C. and referred to as absolutely dry wood (atro wood: absolutely dry wood). The proportion of adhesive is given as 100% solids, i.e. without any added liquid.

To provide chips, lignocellulosic material such as wood, e.g. round wood, fresh wood, waste wood or residual wood or annual plants, typically straw or bagasse, is comminuted in a single or multi-stage chipping process. Typical devices for chipping wood include drum chippers, disk chippers and knife ring chippers. In addition to the chip material obtained from the chipping process, sawdust and wood shavings can also be provided, for example. The chip material preferably has a length of 0.5 mm to 50 mm, a width of 0.1 to 20 mm and a thickness of 0.05 mm to 2 mm. A distinction is often made between coarse chip material with a length of 5 mm to 50 mm, a width of 1 to 20 mm and a thickness of 0.2 to 2 mm and fine chip material with a length of 0.5 mm to 25 mm, a width of 0.1 to 5 mm and a thickness of 0.05 to 1 mm.

If the chips have moisture, as is usual for wood chips from fresh wood, for example, the moisture content should be adjusted before pressing the particle mat so that after pressing, especially under constant climatic conditions without water storage, a dimensionally stable, non-swelling or shrinking particle board is obtained. During pressing, e.g. the chipboard process, it is preferable for the chips to have a moisture content of 1 wt. %/atro wood to 4 wt. %/atro wood before applying binder. The chip material is dried to achieve the desired moisture content.

The chip material can be sorted, e.g. sieved, before or preferably after drying. During sorting, for example, the chips are divided into four fractions (dust, fine chips, coarse chips and oversized chips). Dust is preferably separated from the other fractions and is preferably used for energy recovery. Oversized and/or coarse chip material can be screened out and preferably re-shredded.

The inventors have recognized that the high adhesive content when applying binder to the chips allows the manufacturing of a water-resistant and thus also moisture-resistant particle board, which also has a high strength. Surprisingly, it has also been found that swelling of the particle board, e.g. due to 24 hours of water storage, is reversible due to the high adhesive content. The determination of the swelling behavior is preferably carried out according to DIN EN 317. The particle board regains its initial dimensions after 24 hours of re-drying, e.g. at room temperature, e.g. initial length, initial width and initial thickness before 24 hours of water storage. From this it can be concluded that the adhesive bonds remain essentially damage-free during exposure to water. This swelling-shrinkage behavior has not been observed in particle boards so far; instead, a partial, irreversible residual deformation was common. The complete recovery of the deformation caused by swelling opens up new areas of application for particle board.

According to the invention for manufacturing the particle board an adhesive is used which has a first, thermosetting component and a second, thermoplastic component. The adhesive is used in a proportion of at least 12 wt %/atro wood to 60 wt %/atro wood, preferably from 15 wt %/atro wood to 45 wt %/atro wood, particularly preferably from 18 wt %/atro wood to 35 wt %/atro wood, especially from 20 wt %/atro wood to 33 wt %/atro wood, advantageously from 24 wt %/atro wood to 31 wt %/atro wood.

According to an advantageous embodiment of the invention, a condensation resin, in particular aminoplasts, such as melamine formaldehyde resin, urea formaldehyde resin (UF resin), or benzoguanamine resin, as well as phenoplasts, such as phenol formaldehyde resin (PF resin), are used as thermosetting component, individually or in a mixture. Aminoplasts are used in aqueous solution, e.g. as melamine resin, usually as melamine formaldehyde resin (MF resin), whereby the solids content of the aminoplast is preferably at least 45% by weight relative to the aqueous solution; advantageously, the solids content is over 50% by weight. The upper limit of the solids content is determined by the solubility and, if applicable, the processability of the aminoplast in the production process, e.g. in spray nozzles or high-pressure gluing processes.

Preferably, the adhesive has melamine resin, e.g. MF resin (melamine formaldehyde resin), as at least the first component. Melamine resin is preferred because it has low swelling and low hygroscopicity and is resistant to hydrolysis. Alternatives are phenolic resin, urea resin or mixtures or combinations of several of these thermosetting first components. Although urea resin is not resistant to hot water, it can surprisingly be used, especially in mixture with melamine resin and/or phenolic resin, for manufacturing the particle board according to the invention. In particular, melamine resin can be used either alone as the first component or in combination with one or more of the other thermosetting components. The proportion of the UF resin is preferably up to 50% by weight of the MF resin or PF resin, without impairing the water-resistance or strength of the particle board.

In combination, in the context of the present invention, means that mixtures of first component resins may be used, wherein either the mixture of two or more first component resins is applied to the chip material simultaneously. Or several different resins of the first component are used one after the other, for example because they cannot be used in a mixture or because separate application of different resins of the first component or individual resins of the first component of the adhesive has advantageous effects, for example on the subsequent product properties and/or application properties.

Preferably, technical diphenylmethane diisocyanate (PMDI) is applied to the chip material as the second, thermoplastic component of the adhesive. Alternatively or additionally, other substances such as methylene diphenyl isocyanate (MDI), also in emulsified form as eMDI, but also polyurethane can be used as the second component. The proportion of the second component is preferably more than 1% by weight, in particular 3% by weight or more, advantageously 5% by weight or more, in each case based on atro wood. This means that the proportion of the second component, e.g. PMDI, in the particle board according to the invention is significantly higher than in conventional particle boards. According to the invention, the second component of the adhesive, e.g. PMDI, is also used in a multi-layered structure of the board in the surface layers of the particle board according to the invention. Preferably, the second component is used in equal amounts in the core layer and in the surface layer. Here too, several substances that are suitable as second components can be applied to chip materials either in a mixture with one another at the same time or individually one after the other.

Preferably, at least one third component, for example polyol or polyether, can be added to the first and second components of the adhesive, in each case preferably as a solid. The third component can be added in a proportion of up to 15% by weight, preferably up to 10% by weight, particularly preferably in a proportion of 2 to 5% by weight relative to the total amount of the adhesive.

According to an advantageous embodiment, the elastic properties of the particle board can be modified, in particular improved, by adding an elastomer or thermoplastic which is used as an elasticizing additive, for example by adding polyvinyl acetate (PVAc) or ethyl vinyl acetate. Particularly preferably, an elastomer or thermoplastic is applied to the chip material as an elasticizing additive, in particular in addition to the first and second components of the adhesive. Advantageously, the elasticizing additive is not added to the first or second component of the adhesive or applied to the chips with one of the components of the adhesive. Acrylate, styrene acrylate or polyurethane (PU) are preferably used for elasticizing the particle board according to the invention, according to the invention in the form of a liquid additive such as a dispersion or emulsion, because they are water-resistant. Acrylate, styrene acrylate and PU with a glass transition temperature of TG less than 0° C. are preferred. However, mono or diethylene glycol are also suitable for elasticizing the particle board. The above-mentioned elasticizing additives can be used on their own or in a mixture. The addition of elastomers or thermoplastics reduces the brittleness of the particle board and improves its elastic properties, e.g. the modulus of elasticity. The addition of elasticizing additives also improves the flatness of the particle board according to the invention. The elasticizing additive, calculated as a solid, is used in proportion to the total amount of the particle board (atro) in an amount of preferably 1 wt. % to 7 wt. %, advantageously 2 wt. % to 7 wt. %, preferably 2 wt. % to 6 wt. %, particularly preferably 2.5 wt. % to 5.5 wt. %. The elasticizing additives are added, for example, to the adhesive, e.g. melamine resin, before application to the chip material and are applied to the chips together with the adhesive. Preferably, the elasticizing agent is applied to the chips before or, more preferably, after the adhesive.

As described above, a first and a second, optionally also more components are used in combination as an adhesive. It is preferred if the adhesive predominantly has a first component, in particular melamine resin. It is further preferred if the proportion of the first component in the total amount of the adhesive exceeds 15% by weight, in particular 20% by weight. The first component and the second component of the adhesive can be continuously adjusted within a wide range depending on the requirements of the particle board. This preferably applies to both the core layer and the other layers in the case of a multi-layered board structure. They are preferably applied to the chip material in a ratio of 2:1, preferably 3:1, particularly preferably 4:1 or 5:1 of first component to second component or in a ratio between these values. If the particle board according to the invention has surface layers, a higher proportion of the first component of the adhesive is preferably used compared to the core layer.

The adhesive is usually provided in liquid form, but can also be present as a solid, e.g. in the form of particles or powder. The adhesive can be provided in pure form or—which is the rule—in liquid form in proportion either in solvent or in water correspondingly as a dispersion or emulsion. In the context of the present invention, adhesive is always specified in relation to 100% solids, i.e. without, for example, the solvent or water content. The application, in particular application of the adhesive to the chip material is usually carried out by spraying, for example by a plurality of nozzles, for example high-pressure nozzles, which generate a spray mist of the adhesive and which may be arranged around a downward flow of chips, for example. Typical embodiments for such a gluing device are, for example, a so-called drop chute and/or additionally a conventional gluing mixer, which are used in chipboard production. Coarse chips are preferably treated with adhesive in a drop chute and then guided through a conventional gluing mixer, whereby one or more of the components of the adhesive are preferably applied in this gluing mixer. Application of adhesive on fine chip material carried out in a conventional gluing mixer and/or a drop chute.

The surface of the chips is wetted with droplets of adhesive or an adhesive mist. The chips wetted with adhesive are formed into a particle mat and then pressed. If a thermosetting adhesive is used, the adhesive cures under the effect of increased pressure and temperature; it polymerizes, for example, in an irreversible addition or condensation reaction. If a thermoplastic adhesive is used, it sets in a thermally reversible manner. The thermoplastic adhesive anchors itself mechanically to the chip material during pressing. Both components of the adhesive are preferably used in combination with each other.

Depending on the type, quantity or combination of the components of the adhesive, it can preferably be applied to the chip material in a single pass or in several passes. Optionally, the chip material can be dried after applying, for example, one component of the adhesive.

As is usual with chip material, the forming of the particle mat is usually carried out by scattering, for example using the wind scattering method and/or the throw scattering method. The chips, on which the entire amount of adhesive is applied, are scattered onto a carrier, usually a conveyor belt, e.g. in a homogeneous layer or in several layers, whereby the layers may have a different composition in terms of chips, adhesive, elasticizing additive or optionally additives. The scattered particle mat is optionally first pre-compacted on the carrier by a pre-press and then pressed in a press. The press acts on the upper and lower face of the particle mat or particle board by means of press elements, e.g. press plates or press belts. During curing or setting, which is essentially carried out on the upper and lower face of the particle mat under the influence of pressure and temperature, a particle board is produced with a width and optionally a length determined by the press or, in the case of a continuous press, an infinite length and a thickness determined by the distance between the press elements.

In principle, any press that applies sufficient pressure and temperature is suitable for manufacturing particle boards, both a plate press, in which the particle mat or particle board is pressed between two metal sheets, and continuous hot presses, e.g. a continuous double-belt hot press in the form of circulating, heated metal press belts. In this press, the particle mat or the particle board is pressed between two circulating press belts and the particle board being formed is transported through the press at a predetermined speed by the circulating press belts. Preferably, hot presses are used whose press elements, e.g. in the form of press plates or circulating press belts, are heated to a predetermined temperature. Suitable pressing temperatures, measured as the temperature of the pressing elements, can be selected from 150° C. to 240° C., preferably from 160° C. to 220° C. The thinner the board, the lower the pressing temperature can be selected. Suitable pressing pressures are, for example, in a range from 2 N/mm² to 5 N/mm², preferably 3 N/mm² to 5 N/mm², particularly preferably 3.5 N/mm² to 5 N/mm².

The pressing factor, i.e. the time of action of the pressing elements on the particle mat, is advantageously at least 6 seconds/mm board thickness (hereinafter: s/mm) to 20 s/mm, preferably 8 s/mm to 18 s/mm, particularly preferably 9 s/mm to 15 s/mm. This means that the pressing factor is significantly higher than for comparable, known standard particleboards of type P₂ according to DIN EN 312, where it is up to 5.5 s/mm.

It is particularly preferable to press the particle mat into a particle board with an odd number of layers. For example, the particle board has three or five superimposed layers. In a particle board with three layers, for example, a core layer is arranged between two surface layers. Preferably, the chips are already scattered to form the different layers when the particle mat is formed. The surface layers preferably have mostly fine chips, which are preferably scattered using the wind scattering method. The core layer preferably contains mostly coarse chip material, which is scattered, for example, using the throw scattering method. The core layer typically consists of a proportion of at least 30% by weight, preferably at least 45% by weight, particularly preferably at least 60% by weight of a pressed particle board. The surface layers are spread symmetrically or asymmetrically in relation to their proportion by weight. If the particle board according to the invention consists of a single-layered structure, different chip fractions of the coarse and fine chips described above are combined in one layer.

The actual hot pressing process can be preceded by a pre-press for compacting the particle mat. In principle, a release agent can be applied, in particular sprayed, to the carrier, e.g. the conveyor or forming belt and/or the top of the cake. It is particularly preferable to apply the release agent, e.g. a liquid containing various polymers, especially silicone, to the press elements of the press, which prevents the particle mat/particle board from sticking to the press elements. The release agents are preferably mixed with a fluid medium, in particular water, for applying to the press elements.

Optionally, a device for cooling the particle board can be connected downstream of the press, in particular a device for cooling under a predetermined pressing pressure, which can be lower than the pressing pressure during pressing of the particle board. Alternatively and/or additionally, the particle board can be cooled at room temperature.

One or more additives, e.g. antioxidants, light stabilizers, antistatic agents, colorants, fungicides, flame retardants, agents for adjusting the thermal or electrical conductivity, or one or more fillers can also be used for manufacturing the particle board according to the invention. Mineral particles, for example, but also ceramic, synthetic or glass or plastic particles can be used as fillers. A combination of additives or fillers can also be applied to the chip material, either individually or as a mixture. Fillers and/or additives can also be applied, in particular applied in a mixture with the adhesive.

According to an advantageous embodiment of the invention, a hydrophobizing agent is applied to the chip mat prior to pressing the chip material, in particular after application of the binder onto the chips. The hydrophobizing agents provided are, for example, paraffin or wax, which are typically used in amounts of up to 5% by weight/atro wood, usually in amounts of up to 2% by weight/atro wood, often in an amount of 0.1% by weight/atro wood to 1% by weight/atro wood, optionally up to 1.5% by weight/atro wood. The use of hydrophobizing agents helps to reduce the tendency of the particle board to swell and to increase its moisture resistance.

According to an advantageous further development of the invention, the particle board is sanded after pressing. For this purpose, a sanding device with an abrasive, e.g. an abrasive paper and/or preferably an abrasive belt, may be provided. Sanding is usually carried out in two sanding passes, with abrasives having a grain size of 50-60 being used in the first sanding pass and 80-100 being used in the second sanding pass. The particle board according to the invention has a harder surface compared to known particle board according to DIN EN 312, for said harder surface a coarser grain size of the abrasive is preferred. Preferably, the grain size in both sanding passes is a maximum of 60, preferably a maximum of 50, particularly preferably a maximum of 40.

The particle board produced by the method described above can be adapted to different requirements by different combinations of chips, adhesive, fillers and optionally other additives such as waxes. It is therefore expressly pointed out that the features described in connection with the present invention can be freely combined with each other.

The invention further relates to a particle board with an adhesive content of at least 12%/atro wood. The particle board is manufactured in particular by the method described above. The particle board according to the invention is preferably water-resistant and thus also moisture-resistant. It has an excellent and unusual swelling and shrinkage behavior, in which low swelling is accompanied by extensive regression of the swelling during subsequent drying.

The particle board according to the invention is board-shaped as a result of the pressing, i.e. it generally has two main surfaces, which are also referred to below as the upper and lower face. The upper and lower faces are spaced apart by the thickness of the particle board. The narrow faces of the particle board, which merge into the upper and lower faces at the edges, extend between the upper and lower faces. The thickness of the finished particle board can range from 2 mm to 80 mm, typically between 3 mm and 50 mm, usually between 3 mm and 32 mm. A typical application may require a particle board thickness of 6 mm to 32 mm. The particle board may have smooth main surfaces; however, the upper and/or lower faces may also be embossed or milled or otherwise machined, resulting in a variable thickness of the particle board based on the area of the particle board.

The particle board preferably has an odd number of layers across its thickness. For example, it is single-layered, three-layered or five-layered. The narrow faces of the particle board according to the invention can be machined using conventional tools. They can be sawn, cut or milled. The maximum length and width of the particle board can be cut to length as required, for example in the course of finishing. Smaller dimensions can be manufactured, for example, by cutting up the particle board originally manufactured in the press. Typical dimensions of the particle board can be 6700 mm (length)×2500 mm (width) after manufacturing in the press, 1380 mm×195 mm, after dividing into floor, wall or ceiling panels or 3048 mm×2800 mm. The latter format is particularly suitable for use in construction, as the width of the board corresponds to a standard storey height.

Advantageously, the particle board according to the invention has only a minimum thickness swelling, in particular according to the test method described in DIN EN 317, which is less than 5%, advantageously less than 4%, preferably less than 3%, particularly preferably less than 2.5%, in relation to the original board thickness. An uncoated particle board also advantageously has an edge swelling of less than 6%, preferably less than 5%, in accordance with the test method described in EN-13329, and a coated particle board particularly preferably has an edge swelling of less than 4%. The swelling can be reduced by more than 90% compared to a standard chipboard of the same thickness made from the same chip material but with less adhesive and other types of adhesive. A value of less than 5% for the edge swelling of the uncoated particle board and less than 4% for the edge swelling of a coated particle board is therefore an exceptional improvement compared to known particle boards according to DIN EN 312.

The average density of the particle board according to the invention is preferably 800 kg/m³ to 1,000 kg/m³, preferably 830 kg/m³ to 970 kg/m³, particularly preferably 850 kg/m³ to 950 kg/m³. It is thus approx. 100 kg/m³ to 300 kg/m³ higher than known particle boards of type P₂ according to DIN EN 312.

The particle board according to the invention has very good strength properties, in particular a high transverse tensile strength, which is at least 2.5 N/mm², preferably up to 3 N/mm², in particular up to 4 N/mm². Preferably, the particle board has a modulus of elasticity of 3000 N/mm² to 5000 N/mm², advantageously of 3500 to 5000 N/mm², particularly preferably of 4000 to 5000 N/mm². The good strength properties mean that fewer fasteners, e.g. screws, need to be used to fasten the particle board according to the invention because the individual fastener has a better hold in the board. The higher transverse tensile strength also allows more intensive processing of a particle board according to the invention, e.g. milling simple profiles into the side edge of a board. For example, at least one simple profile, such as a tongue/groove profile, can be machined into the narrow face of a particle board, which aligns two interlocking boards with each other in both the vertical and horizontal directions. A high flexural strength of the particle board of at least 35 N/mm², preferably at least 40 N/mm², allows it to be used as a structural element, e.g. wall reinforcement.

The invention further relates to the use of the particle board described above for structural purposes indoors and outdoors. The particle board according to the invention is characterized by the fact that it can be used in a variety of ways due to the minimal swelling, in particular the reduced thickness swelling in the area of the narrow faces. In interior construction, the particle board can be used, for example, as a floor board or as a floor covering, in each case with or without a coating. In contrast to non-water-resistant floor boards or floor coverings, for example, it can also be used in damp and wet rooms, in particular because the narrow faces, which optionally have an edge profile where the board is freely accessible to moisture, no longer swell significantly under the influence of water or high humidity or return almost completely to their original dimensions when drying.

This means, for example, that an essentially non-swelling, dimensionally stable particle board with high strength values that is dimensionally stable against water and humidity and is not limited to narrow formats can now be manufactured on known devices for manufacturing wood-based boards.

Of course, the particle board according to the invention can also be used as a wall panel or ceiling panel, as a furniture panel and as a construction panel, in particular in the finishing of damp and wet rooms or of laboratory and technical rooms or workshops, but is not limited to this. In exterior construction, the particle board according to the invention is also suitable as a construction board, typically e.g. as a façade board, for exterior window sills, coverings including roof coverings and wall elements.

The particle board according to the invention can be used, for example, for terrace construction or outdoor flooring. In this way, it is possible to use the same flooring or floor coverings for indoor and adjacent outdoor areas (terraces, balconies, façades, access routes). Preferably, the particle board according to the invention can be used for constructions, in particular furniture, in outdoor areas. The finishing of workshops, production halls or stables, for example, can easily be carried out with the particle board according to the invention. Furthermore, due to its water-resistant properties, the particle board according to the invention can also be used, for example, for fire protection elements and construction elements in shipbuilding, in particular if it is provided or coated with fire protection substances.

The particle board according to the invention is already suitable for the aforementioned uses in its uncoated state. As a coated particle board, it is even more suitable due to further reduced deformation as a result of exposure to water. The particle board can optionally be configured as a panel and, if required, be provided with a profile at the edges. The profile is preferably used to fix two panels one to another. Alternatively, two panels arranged next to each other can also be joined butt to butt. For example, they can be fixed in place using a double-sided adhesive tape arranged in the area to the side of a joint between the directly adjacent panels. It is also possible to glue directly adjacent panels or boards together, preferably using a waterproof adhesive.

### BRIEF DESCRIPTION OF THE DRAWINGS

In the following, an exemplary embodiment of the invention is explained in more detail with reference to drawings. These show in:

FIG. 1 a flow chart of a method for manufacturing a particle board;

FIG. 2 a schematic representation of a perspective view of a particle board;

FIG. 3 an raw density profile of an exemplary embodiment (invention 1) of the particle board according to the invention and

FIG. 4 a raw density profile of a standard particleboard of type P₂ according to DIN EN 312.

### DETAILED DESCRIPTION

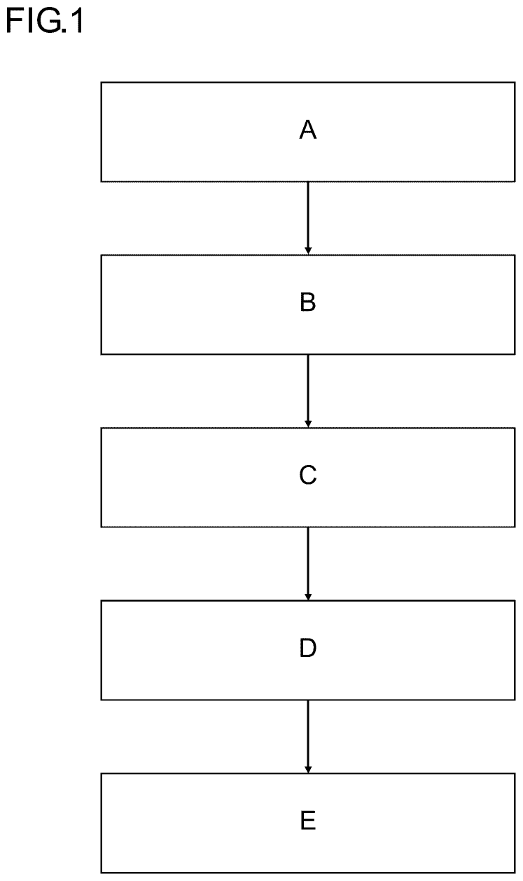

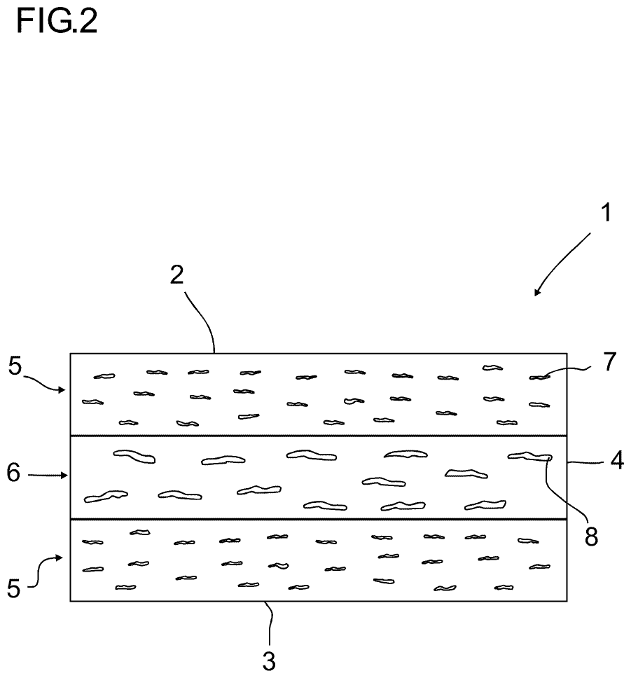

FIG. 1 shows a flow chart of a method for manufacturing a particle board 1 shown in FIG. 2.

The method has the following steps:
Providing chip material (A)
Providing adhesive (B)
Application of the adhesive (C)
Forming a particle mat (D)
Pressing the particle mat (E).

To provide chips, lignocellulosic material, typically wood, e.g. round wood, fresh wood, waste wood or residual wood, but also annual plants such as straw or bagasse, is first processed into chips 7, 8 in a single or multi-stage chipping process, for example in drum chippers and disk chippers and knife ring chippers. The chips 7, 8 are then dried in a single-pass or three-pass drum dryer, for example, and fractionated into fine chips 7 and coarse chips 8 using a sieve, for example.

The adhesive used is a mixture of a first, thermosetting component and a second, thermoplastic component. The thermosetting component can be selected from aminoplastics, such as melamine resin, benzoguanamine resin or urea resin, or from phenoplastics, such as phenolic resin, which can be used individually or in a mixture. The second component is selected from MDI, eMDI, PMDI or polyurethane, which can also be used individually or in a mixture. Preferably, as in the exemplary embodiment, melamine resin is provided in combination with PMDI. After the chips and adhesive have been provided, application, in this case, for example, adding of the adhesive to the chips follows.

The adhesive is sprayed through nozzles in a known device for applying binder to chip material. The spray mist generated by the nozzles is deposited on the surface of the chip material passing through the spray mist, e.g. falling from top to bottom through the spray mist of adhesive. In addition to the adhesive, a hydrophobizing agent, here e.g. paraffin or hydro wax, is applied to the chip material in a proportion of 1% by weight/atro wood. The high proportion of adhesive according to the invention, in this case 25% by weight/atro wood in the surface layers and 30% by weight/atro wood in the core layer, can be carried out in one or more passes, depending on the type, quantity and combination of the components of the adhesive. If necessary, the chip material can be dried after applying one component of the adhesive. The chip material is dried after the adhesive has been fully applied.

The adhesive is applied separately, e.g. for fine chip materials from which surface layers are to be manufactured and for coarser chips for the core layer. The composition of the adhesive can also be selected differently for fine chip material than for coarser chip material, e.g. with a lower proportion of a first, thermoplastic component of the adhesive compared to the adhesive for coarser chip material. In the present case, the adhesive is used with a first component of melamine resin and a second component of PMDI in a ratio of 4:1 for the surface layer and in a ratio of 5:1 for the core layer, with an average of 27.5% by weight based on atro wood being used, divided into 25% by weight/atro wood adhesive in the surface layers, which each take up 25%, together 50% of the board mass, and 30% by weight/atro wood adhesive in the core layer, which also takes up 50% of the board mass. It is obvious that the proportions of the core layer and surface layers can vary, as can the amount of adhesive used.

After application of the adhesive and drying, the chips 7, 8 are applied in a known scattering device and scattered to form a particle mat, e.g. to form a lower surface layer 5, a core layer 6 and an upper surface layer 5. The fine chips 7 for the surface layers 6 are deposited, for example by means of the known wind scattering method. The coarser chips 8 for the core layer 6 are deposited, e.g. by means of the known throw scattering method.

The three-layer particle mat is then pressed in a known continuously operating double belt hot press at temperatures of 160° C. to 240° C., here for example 180° C. and a pressure of up to 5 N/mm², here: 4.5 N/mm² at a pressing factor of 6 s/mm to 20 s/mm, here: 9.35 s/mm. Before and/or during the pressing of the particle mat, a release agent mixed with water, e.g. a liquid containing various polymers, here a liquid containing silicone is applied to the press plates or press belts of the press to protect against bonding. After pressing, the particle board is advantageously cooled at room temperature. In a known sanding device, the upper and lower faces 2, 3 of the particle board are then each sanded in two sanding passes using an abrasive with a grain size of, for example, 50 in this case.

In further steps, the particle board can be cut to size, milled and/or coated, e.g. painted, laminated or printed. It is then usually stacked and stored and/or prepared for transportation.

According to a preferred embodiment, as shown in FIG. 2, the particle board 1 produced using the method described above has an upper face 2, a lower face 3 and a narrow face 4 as well as an upper and a lower surface layer (DS) 5 and a core layer (MS) 6 arranged between the surface layers. The core layer 6 essentially has coarser chip material 8 and the surface layers 5 essentially have fine chip material 7. The chip materials 7 and 8 are each embedded in an adhesive. The proportion of adhesive is more than 15% by weight/atro wood, in this case an average of 27.5% by weight/atro wood.

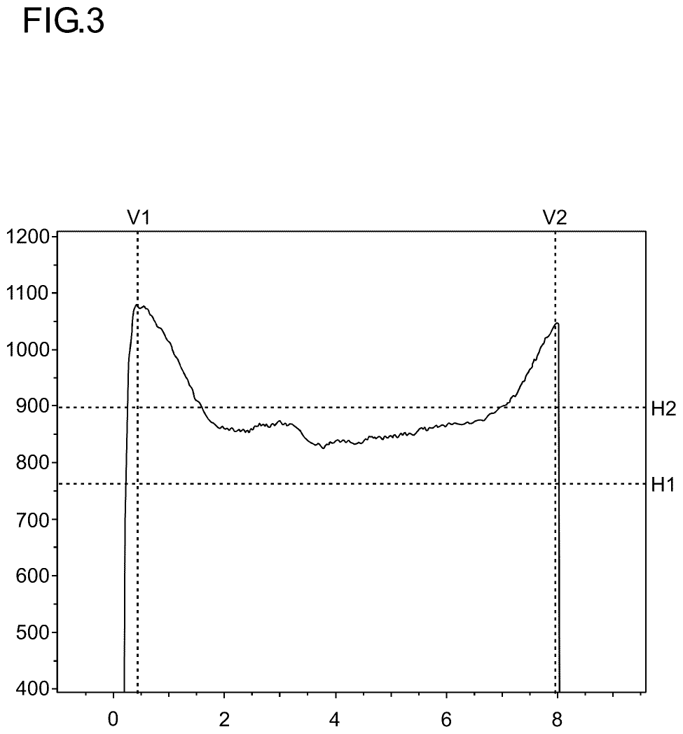

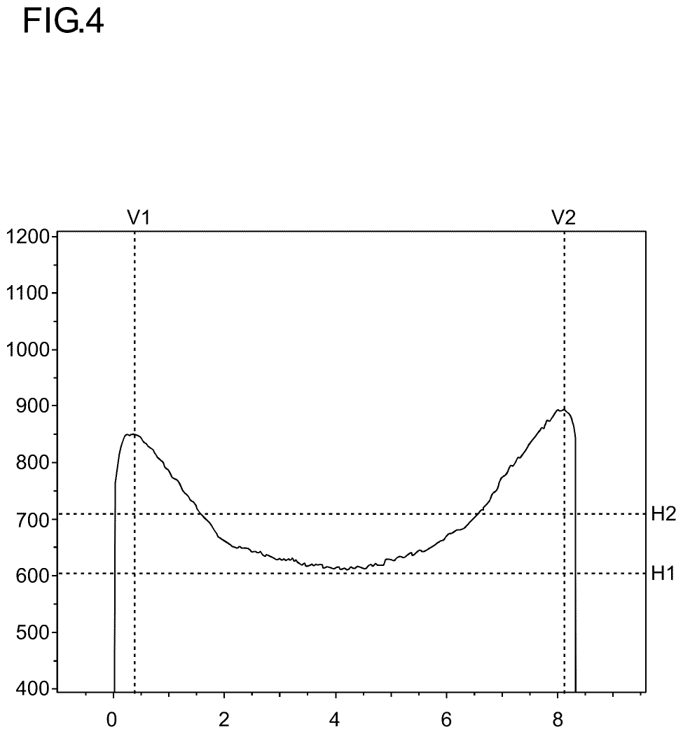

The particle board 1 is compared to a standard particle board of class P₂ (DIN EN 312:2010), which was manufactured from the same chip material and with the same components of the adhesive, but with a significantly lower adhesive content in the middle and surface layers, whereby the surface layers of the standard particle board P₂ does not contain PMDI. Overall, the proportion of PMDI in the core layer of a standard particle board (0.1 to 0.6 wt. %/atro wood) is much lower than in the particle board according to the invention (5 wt. %/atro wood). FIGS. 3 and 4 show the density distribution over the cross-section of the particle board. In each case, the density in kg/m³ is plotted over the position along the board thickness in mm. FIGS. 3 and 4 also show the average density represented by line H₁, 85% of the average density represented by line H₂, the maximum density on the left (first surface layer) represented by line V₁ and the maximum density on the right (second surface layer) represented by line V₂. The particle board according to the invention has an average density of 850 kg/m³ to 950 kg/m³, here according to FIG. 3 e.g. 897 kg/m³. In comparison, the standard chipboard P₂ has an average density of 640 to 720 kg/mm³, here according to FIG. 4 e.g. 707 kg/mm³, with a comparable thickness. Furthermore, the particle board according to the invention has a maximum density of approx. 1080 kg/mm³ in the surface layers 5 (lines V₁ and V₂). In comparison, the standard chipboard P₂ has a maximum density of approx. 850 kg/mm³ in the surface layers (lines V₁ and V₂).

Tables 1 and 2 below show the two particle boards (invention 1 and standard) in comparison, with the board thickness in mm as the gross value (before sanding) and the density in kg/m³. The particle boards were each evaluated according to transverse tensile strength (DIN EN 319), swelling (measured according to DIN EN 317) and edge swelling (measured according to DIN EN 13329) (see Table 2).

Furthermore, Table 1 shows test results of two further exemplary embodiments (invention 2 and invention 3) of the particle board according to the invention. The second exemplary embodiment differs from the first exemplary embodiment by a higher board thickness of 19 mm, a lower target density of 660 kg/m³, which is achieved by a low chip input of 490 kg/m³ and an associated lower adhesive input of 130 kg/m³. On the other hand, the third exemplary embodiment differs from the first exemplary embodiment with the same board thickness of 8 mm by a lower target density of 720 kg/m³, which is also achieved by a low chip input of 550 kg/m³ and an associated lower adhesive input of 150 kg/m³. These lighter particle boards also have improved strength properties and improved water-resistant properties compared to the standard particle board P₂.

TABLE 1
Comparative tests on a standard particle board
and a particle board according to the invention

| | | | | | | Adhesive |
|---|---|---|---|---|---|---|
| | Gross | | Chip | Binder- | PMDI | applica- |
| | thick- | Target | input | factor | factor | tion |
| | ness | density | quantity | (DS/MS) | (DS/MS | quantity |
| | Unit | | | | | |
| Panel type | [mm] | [kg/m]³ | [kg/m]³ | [%] | [%] | [kg/m]³ |
| Invention 1 | 8 | 880 | 670 | 25/20 | 5/5 | 185 |
| Invention 2 | 19 | 660 | 490 | 25/20 | 5/5 | 130 |
| Invention 3 | 8 | 720 | 550 | 25/20 | 5/5 | 150 |
| Standard | 8 | 720 | 633 | 6.2/10.4 | —/0.4 | 55 |

TABLE 2
Comparative tests on swelling and strength values
of the standard particle board and the particle
board according to the invention from Table 1

| | | Modulus | Transverse | Swelling | |
|---|---|---|---|---|---|
| | Bending | of | tensile | Raw | Edge |
| | strength | elasticity | strength | panel | swelling |
| | Unit | | | | |
| Panel type | [N/mm²] | [N/mm²] | [N/mm²] | [%] | [%] |
| Invention 1 | 38 | 4500 | 3 | 2-3 | 3-4 |
| Standard | <25 | <3000 | <1 | 28 | —* |

*not measurable

The particle board according to the invention must be compacted more than a conventional standard particle board. The adhesive factor is approximately 2 to 5 times higher than for the prior art particle board, in the examples according to Table 1 approximately 3 times higher. The proportion of the second component of the adhesive is much higher than in the standard particleboard; it is disproportionately increased compared to the increased use of the first component, by more than 10 times. The particle board according to the invention has a swelling of the raw board that is reduced by a factor of 10 (DIN EN 317) and a transverse tensile strength that is more than three times higher (DIN EN 319). In addition, the particle board according to the invention has a modulus of elasticity that is more than 1.5 times higher and a flexural strength that is more than 1.5 times higher compared to the standard particle board P₂.

After coating the upper and lower face, the edge swelling is measured on a coated board. Only the narrow faces of the particle board are exposed to water, as the upper and lower face of the board are sealed by the coating and are no longer accessible to water. This test is particularly important for floor coverings because the narrow faces of the flooring cannot usually be sealed and are therefore exposed to water. Here, a significantly reduced edge swelling is shown for the particle board according to the invention in comparison with a known particle board whose edge swelling is so high that the value could not be measured. Both the standard particle board and the particle board according to the invention were manufactured on the same industrial production facilities.

Table 3 shows a formulation for a further exemplary embodiment (invention 4) of the particle board according to the invention with a lower proportion of the first, thermosetting component of the adhesive (binder-factor) in the surface layers and in the core layer compared to the other exemplary embodiments. In this exemplary embodiment, the adhesive has a melamine formaldehyde resin as the first thermosetting component. The particle board according to this exemplary embodiment is characterized by an elasticizing additive, here for example styrene acrylate, in the surface layers, which improves the flatness of the particle board according to the invention. The components of the formulation are given in % by weight/atro wood. Furthermore, a hydrophobizing agent (emulsion), for example a hydro wax, and a hardener, for example ammonium sulphate, are added to the particle board according to this exemplary embodiment.

TABLE 3
Formulation of a particle board according to the invention

| | Binder- | | | | Elasticizing |
|---|---|---|---|---|---|
| | factor | PMDI | Emulsion | Hardener | additive |
| | Unit | | | | |
| Component | [%] | [%] | [%] | [%] | [%] |
| Core layer | 15 | 5 | 1 | 1.8 | / |
| Surface layers | 15 | 5 | 1 | 1.8 | 3 |

### LIST OF REFERENCE SYMBOLS

1 Particle board
2 Upper face
3 Lower face
4 Narrow surface
5 Surface layer
6 Core layer
7 Fine chip material
8 Coarse chip material
A Providing chip material
B Providing adhesive
C Applying the adhesive
D Forming a particle mat
E Pressing the particle mat
H₁ Medium density
H₂ 85% of the average density
V₁ Maximum density left
V₂ Maximum density right

1. Method for manufacturing a particle board, comprising the steps of
providing wood chips (7,8) obtained from chipping,
providing at least one adhesive,
application of the adhesive to the chip material (7, 8), wherein an adhesive content of at least 12% by weight/atro of wood is applied to the chips (7, 8), wherein
the adhesive has at least a first component of a thermosetting material and a second component of a thermoplastic material
forming a single or multi-layered particle mat and
pressing the particle mat in a hot press to manufacture a particle board (1),
wherein
an elastomer or a thermoplastic is added as an elasticizing additive to modify the elastic properties of the particle board, wherein
the elasticizing additive, calculated as a solid, is used in proportion to the total amount of particle board (atro) in an amount of 1 wt. % up to 7 wt. % and wherein
the second, thermoplastic component of the adhesive is also used in the surface layers in the case of a multi-layered structure of the board and
the elasticizing additive is applied to the chip material in the form of a liquid additive.

2. Method according to claim 1, wherein the first component and the second component of the adhesive are applied to the chip material (7, 8) in a ratio of first component to second component of 2:1 to 5:1.

3. Method according to claim 2, wherein a condensation resin is used as the first, thermosetting component of the adhesive.

4. Method according to claim 2, wherein at least one of technical diphenylmethane diisocyanate PMDI, methylene diphenyl isocyanate MDI, emulsified methylene diphenyl isocyanate eMDI, and polyurethane are used as the second, thermoplastic component of the adhesive, in each case individually or in a mixture.

5. Method according to claim 1, wherein the one or more components of the adhesive are applied individually and/or in a mixture to the chip material (7, 8).

6. Method according to claim 1, wherein acrylate, styrene acrylate or polyurethane is used as the elasticizing additive for elasticizing the particle board.

7. Method according to claim 1, wherein the elasticizing additive is applied to the chip material before or after the adhesive.

8. Method according to claim 1, wherein an adhesive content of at least 15% by weight/atro wood is applied to the chip material (7, 8).

9. Method according to claim 1, wherein the particle board (1) has at least surface layers (5) and a core layer (6), the surface layer (5) and the core layer (6) each having different adhesives and/or different adhesive compositions.

10. Method according to claim 1, wherein the chip materials (7, 8) are pressed in a continuous press with a pressing factor, defined as the time of action of the press elements of the press on the particle mat in relation to the panel thickness, of at least 6 s/mm to 20 s/mm.

11. Method according to claim 1, wherein the chip materials (7, 8) are pressed with a pressing pressure of 2 to 5 MPa.

12. Method according to claim 1, wherein the particle board (1) is sanded after pressing and/or after cooling, wherein an abrasive with a grain size of at most 60 is used.

13. Particle board manufactured by a method according to claim 1, having wood chips obtained from chipping and an adhesive content of at least 12%/atro chips, wherein
the adhesive has at least a first component of a thermosetting material and a second component of a thermoplastic material, wherein
an elastomer or a thermoplastic is added as an elasticizing additive, whereby
the elasticizing additive, calculated as a solid, is used in proportion to the total amount of particle board (atro) in an amount of 1 wt. % to 7 wt.,
wherein
the second, thermoplastic component of the adhesive is also used in the surface layers in the case of a multi-layered structure of the board and
the elasticizing additive is applied to the chip material in the form of a liquid additive.

14. The particle board according to claim 13, wherein the elasticizing additive, calculated as a solid, is used in proportion to the total amount of the particle board (atro) in an amount of 2 wt. % to 7 wt. %.

15. The particle board according to claim 13, further comprising an average density of 800 to 1000 kg/m³.

16. A particle board according to claim 13 incorporated for constructive purposes in interior and exterior areas, for façade panels, exterior window sills, coverings, roof coverings, wall elements and wet rooms.

17-18. (canceled)

19. Method according to claim 3, wherein the condensation resin is at least one of an aminoplast selected from the group consisting of melamine formaldehyde resin, benzoguanamine resin and urea formaldehyde resin; and a phenoplast comprising phenol formaldehyde resin.

20. The particle board according to claim 13, wherein the amount is 2 wt. % to 6 wt. %.

21. The particle board according to claim 15, wherein the average density is 850 to 950 kg/m³.
